(19) United States
(12) Patent Application Publication
(10) Pub. No.: US 2023/0007469 A1
(43) Pub. Date: Jan. 5, 2023

(54) COMMUNICATION APPARATUS, MOBILE COMMUNICATION TERMINAL, COMMUNICATION METHOD AND PROGRAM

(71) Applicant: NIPPON TELEGRAPH AND TELEPHONE CORPORATION, Tokyo (JP)

(72) Inventors: Shingo OKADA, Tokyo (JP); Hisashi KOJIMA, Tokyo (JP)

(21) Appl. No.: 17/756,583

(22) PCT Filed: Dec. 20, 2019
(86) PCT No.: PCT/JP2019/050196

§ 371 Date: May 27, 2022

(51) Int. Cl. H04W 8/26; H04W 64/00; H04L 45/74

(52) U.S. Cl. CPC H04W 8/26; H04W 64/003; H04L 45/74

(57) ABSTRACT

A communication device for use in a system including a database storing a unique identifier and position information for every mobile communication terminal is provided with an acquisition unit that acquires, based on the unique identifier of a mobile communication terminal serving as a communication destination, the position information of the mobile communication terminal serving as the communication destination from the database, and acquires an IP address of a router accommodating the mobile communication terminal serving as the communication destination, based on the acquired position information, and a communication unit that transmits a packet having the IP address in a header.

### TECHNICAL FIELD

The present invention relates to a technology for a communication terminal to communicate with a mobile communication terminal in an IP network.

### BACKGROUND ART

Global IP addresses that are utilized by communication terminals in an IP network are assigned for every network. Thus, a communication terminal to which a global IP address has been assigned cannot move to another network while holding the same IP address. In the case where a communication terminal moves to another network, a global IP address that is managed by the network that the communication terminal is moving to needs to be assigned to the communication terminal.

On the other hand, there are cases where it is desired to always assign the same IP addresses to communication terminals in upper layer applications and services, and to permanently perform communication to the same IP addresses for communication continuity and the like.

Conventional technologies that have been developed for this purpose include IP Mobility Support for IPv4 (Mobile IP) and the Locator/ID Separation Protocol (LISP) (NPL 1).

### CITATION LIST

### Non Patent Literature

[NPL 1] The Locator/ID Separation Protocol (LISP) [Online], available at: https://tools.ietf.org/html/rfc6830 (accessed: Dec. 11, 2019).

### SUMMARY OF THE INVENTION

### Technical Problem

In order for communication terminals to move networks while holding the same IP address, it is necessary to use a technology such as the abovementioned LISP, or to assign a global IP address fixedly to every communication terminal and allow connectivity over the network by utilizing a routing protocol such as BGP to advertise the global IP address held by a communication terminal to the network to which the communication terminal is connected to be propagated throughout the entire network.

However, with both the LISP and path advertisement methods, the information of all the mobile communication terminals must be held by each of devices such as routers and the like. The number of mobile communication terminals is huge, and thus there is a problem in that the amount of data that must be held by each device is huge and it is impossible to hold all the data.

In the case of path advertisement in particular, the routing table normally reduces the data amount by advertising IP addresses in an aggregated manner for every organization, and thus when IP addresses are advertised on a network for every mobile communication terminal, the routing table becomes huge due to being unable to aggregate the IP addresses.

The present invention has been made in view of the above points, and an object of the invention is to provide a technology that enables IP communication from a communication terminal to a mobile communication terminal to be performed, without holding a huge amount of data in each device on the network.

### Means for Solving the Problem

According to the disclosed technology, a communication device for use in a system including a database storing a unique identifier and position information for every mobile communication terminal includes an acquisition unit configured to acquire, based on a unique identifier of a mobile communication terminal serving as a communication destination, position information of the mobile communication terminal serving as the communication destination from the database, and to acquire an IP address of a router accommodating the mobile communication terminal serving as the communication destination, based on the acquired position information, and a communication unit configured to transmit a packet having the IP address in a header.

### Effects of the Invention

According to the disclosed technology, a technology is provided that enables IP communication from a communication terminal to a mobile communication terminal to be performed, without holding a huge amount of data in each device on the network.

### BRIEF DESCRIPTION OF DRAWINGS

FIG. 1 is a system configuration diagram in a first embodiment of the present invention.

FIG. 2 is a diagram for describing an outline of operations of the system.

FIG. 3 is a configuration diagram of a mobile communication terminal.

FIG. 4 is a configuration diagram of a communication terminal.

FIG. 5 is a diagram showing the structure of a table stored in a mobile terminal position information DB.

FIG. 6 is a configuration diagram of an accommodating router specification device.

FIG. 7 is a diagram showing the structure of a table stored in a router accommodation range DB.

FIG. 8 is a diagram for describing operations in the first embodiment.

FIG. 9 is a configuration diagram of a router in a second embodiment.

FIG. 10 is a diagram for describing operations in the second embodiment.

FIG. 11 is a diagram for describing operations in a third embodiment.

FIG. 12 is a diagram for describing operations in a fourth embodiment.

FIG. 13 is a diagram showing an example hardware configuration.

### DESCRIPTION OF EMBODIMENTS

Hereinafter, embodiments of the present invention will be described with reference to the drawings. The embodiments that will be described below are merely examples, and embodiments to which the present invention is applicable are not limited to the following embodiments.

### First Embodiment

<Overall System Configuration>

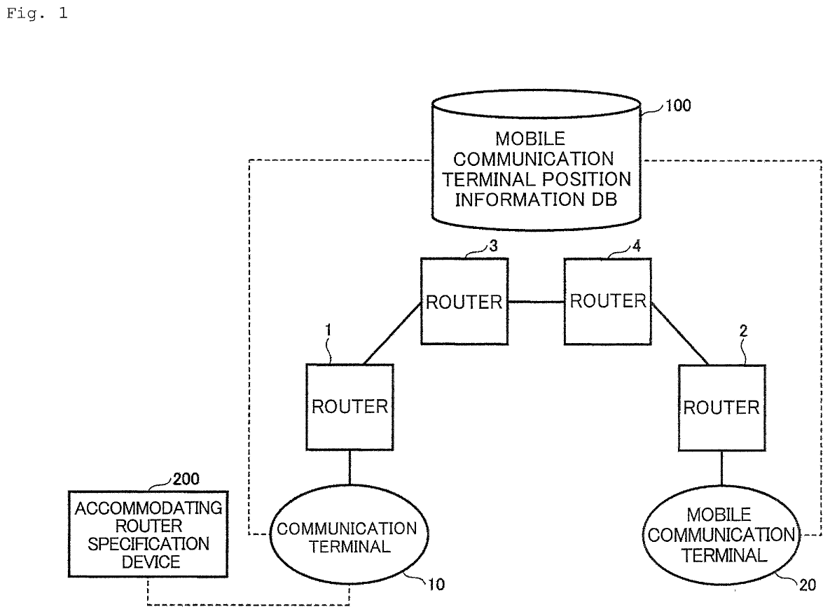

FIG. 1 shows an example configuration of the system in a first embodiment. In the present embodiment, an IP (Internet Protocol) network is constituted by a plurality of routers (routers 1 to 4 are shown as an example in FIG. 1). In FIG. 1, a communication terminal 10 that is connected to the router 1 and a mobile communication terminal 20 that is connected to the router 2 are shown as examples of the large number of communication terminals that exist. Note that the communication terminal 10 may also be a mobile communication terminal, but, in the present embodiment, the distinction is made between a “communication terminal” and a “mobile communication terminal”, given that the mobile communication terminal 20 is assumed to move around. Also, communication terminals and routers may be referred to collectively as “communication devices”.

Routers in the IP network of the present embodiment use a routing protocol to exchange their own respective IP path information and the IP path information of the network and communication terminals that are accommodated in the network, and IP packets (“IP packets” may also be referred to as “packets”) sent from communication terminals are routed and forwarded to communication terminals serving as the communication destination on the basis of this information. In FIG. 1, the path information of the IP address assigned to the mobile communication terminal 20 is, however, only propagated to the router 2 that directly accommodates the mobile communication terminal 20.

As shown in FIG. 1, the system of the present embodiment is provided with a mobile communication terminal position information DB 100 and an accommodating router specification device 200. The mobile communication terminal position information DB 100 is capable of communicating with each communication terminal and router. Communication between the mobile communication terminal position information DB 100 and each communication terminal/router may be performed via the IP network that is used in communication between communication terminals, and may also be performed via a network that is separately provided for use in control.

The accommodating router specification device 200 is also capable of communicating with each communication terminal and router. Similarly, communication between the accommodating router specification device 200 and each communication terminal/router may be performed via the IP network that is used in communication between communication terminals, and may also be performed via a network that is separately provided for use in control.

In relation to the IP addresses held by routers and communication terminals, the present embodiment will be described assuming that IPv6 addresses are used, but operations are similar even in the case of using IPv4 addresses.

Also, the present embodiment will be described with an example of one-way communication from the communication terminal 10 to the mobile communication terminal 20, but the mobile communication terminal 20 also has the functions that are performed by the communication terminal 10, and the present invention is applicable to two-way communication.

<Outline of Operations of System>

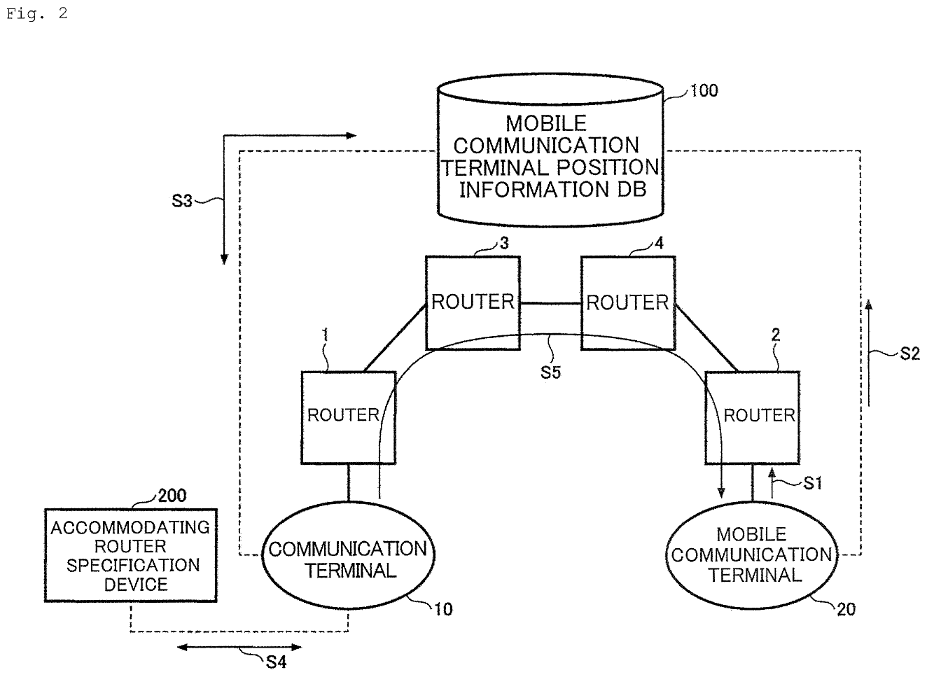

An outline of the operations of the system of the present embodiment will be described, with reference to FIG. 2. In this system, IP packets transmitted from the communication terminal 10 can be forwarded to the mobile communication terminal 20, without all routers on the IP network having the path information up to the mobile communication terminal 20, by the communication terminal 10 specifying the router 2 to which the mobile communication terminal 20 is connected based on the position information of the mobile communication terminal 20.

In S1 (Step 1) of FIG. 2, the mobile communication terminal 20 connected to the router 2 uses a routing protocol or the like to notify a unique identifier such as its own IP address to the router 2: The router 2 holds only the information of the unique identifiers of mobile communication terminals that are accommodated under the router 2.

Furthermore, the mobile communication terminal 20 acquires its own position information such as latitude and longitude using means such as GPS, and, in S2, transmits the set of its own unique identifier and position information to the mobile communication terminal position information DB 100 to be registered. Sets of unique identifier and position information of various mobile communication terminals are stored in the mobile communication terminal position information DB 100.

The communication terminal 10 is able to acquire the unique identifier of the mobile communication terminal 20 by DNS, for example. In the case where the communication terminal 10 communicates with the mobile communication terminal 20, the communication terminal 10, in S3, uses the unique identifier of the mobile communication terminal 20 to make an inquiry for the position information of the mobile communication terminal 20 to the mobile communication terminal position information DB 100, and acquires this position information from the mobile communication terminal position information DB 100.

In S4, the communication terminal 10 makes an inquiry for the accommodating router of the mobile communication terminal 20 to the accommodating router specification device 200, based on the acquired position information. The accommodating router specification device 200 computes the accommodating router 2 from the position information of the mobile communication terminal 20, and replies with the IP address of the accommodating router 2. The communication terminal 10 acquires the IP address of the accommodating router 2.

In S5, the communication terminal 10 transmits a packet. Here, the communication terminal 10 adds an encapsulation protocol of some sort and an IPv6 Segment Routing (SRv6) header to an IP packet addressed to the mobile communication terminal 20, and transmits the IP packet to which the header is added to the obtained IP address (to router 2).

The router 2 removes the header from the packet transmitted from the communication terminal 10, and forwards the packet to the mobile communication terminal 20 on the basis of the path information to the mobile communication terminal 20 that is accommodated under the router 2.

As described above, packets are forwarded to the router 2 accommodating the mobile communication terminal 20, based on the position information of the mobile communication terminal 20, thus enabling IP communication, without all routers on the network having the path information of all mobile communication terminals.

<Device Configuration>

Hereinafter, the configuration of each device will be described.

<Mobile Communication Terminal 20>

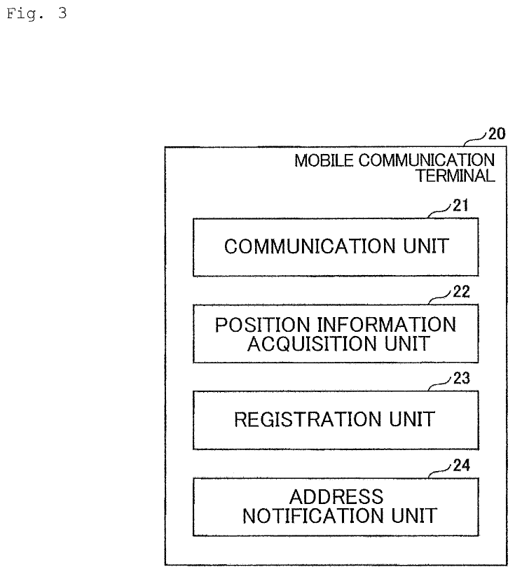

FIG. 3 is a functional configuration diagram of the mobile communication terminal 20. As shown in FIG. 3, the mobile communication terminal 20 has a communication unit 21, a position information acquisition unit 22, a registration unit 23, and an address notification unit 24.

The communication unit 21 transmits and receives packets. The position information acquisition unit 22 acquires position information of the mobile communication terminal 20.

The mobile communication terminal 20 holds a unique identifier such as an IP address. When the mobile communication terminal 20 is accommodated under a router, the registration unit 23 transmits the position information and unique identifier of the mobile communication terminal 20 as a set to the mobile communication terminal position information DB 100 to be registered.

In the present embodiment, the unique identifier of the mobile communication terminal 20 is assumed to be the prefix (upper 64 bits) of the IPv6 address assigned to the mobile communication terminal 20, but this is merely an example. All 128 bits of the IPv6 address, an IPv4 address or information other than this may be used as the unique identifier.

When the mobile communication terminal 20 is accommodated under a router, the address notification unit 24 notifies the prefix (upper 64 bits) of the IPv6 address which is the unique identifier held by the mobile communication terminal 20 to the accommodating router, using a routing protocol such as RIP.

<Communication Terminal 10>

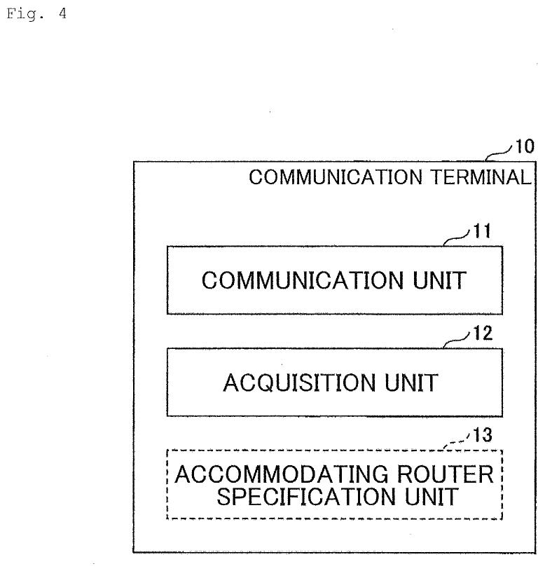

FIG. 4 is a functional configuration diagram of the communication terminal 10. As shown in FIG. 4, the communication terminal 10 has a communication unit 11 and an acquisition unit 12. As will be discussed later, the communication terminal 10 may also include the functions of the accommodating router specification device 200, and this is shown as an accommodating router specification unit 13 with a dotted line.

The communication unit 11 transmits and receives packets. When the communication terminal 10 communicates with the mobile communication terminal 20, the acquisition unit 12 makes an inquiry for position information of the mobile communication terminal 20 to the mobile terminal position information DB 100 with the unique identifier (e.g., IP address) of the mobile communication terminal 20 as a key, and acquires the position information.

Also, the acquisition unit 12 makes an inquiry for the router 2 under which the mobile communication terminal 20 is accommodated to the accommodating router specification device 200 with the acquired position information of the mobile communication terminal 20 as a key, and acquires the IP address of the router 2.

In the case where the communication terminal 10 includes the accommodating router specification unit 13, the accommodating router specification unit 13 specifies the IP address of the accommodating router based on the position information acquired by the acquisition unit 12.

The communication unit 11 encapsulates an IP packet addressed to the mobile communication terminal 20 with the specified accommodating router 2 as the destination, and transmits the encapsulated IP packet.

<Mobile Communication Terminal Position Information DB 100>

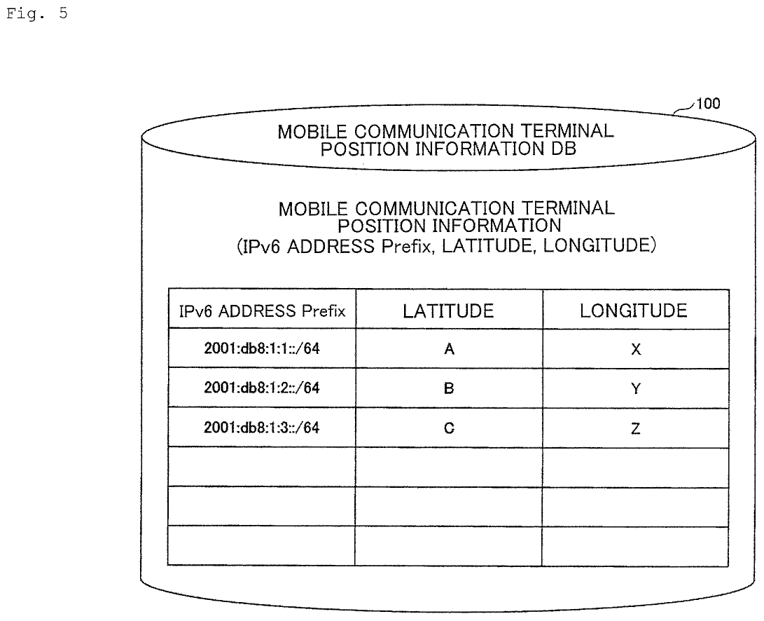

FIG. 5 shows an example of the structure of a table stored in the mobile communication terminal position information DB 100. In the example shown in FIG. 5, the mobile communication terminal position information DB 100 stores, for every mobile communication terminal, the IPv6 address prefix serving as the unique identifier and position information (latitude, longitude) in association with each other.

Also, the mobile communication terminal position information DB 100 has a function of performing searches based on inquiries that use a key, and replying with values corresponding to the key, similarly to a general database server or the like.

<Accommodating Router Specification Device 200>

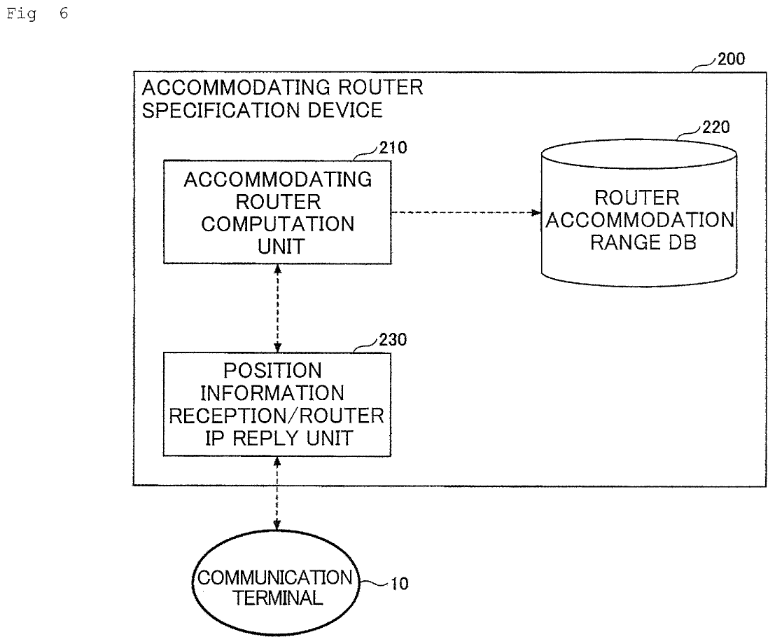

FIG. 6 is a configuration diagram of the accommodating router specification device 200. As shown in FIG. 6, the accommodating router specification device 200 has an accommodating router computation unit 210, a router accommodation range DB 220, and a position information reception/router IP reply unit 230.

The accommodating router computation unit 210, by utilizing the accommodation range of each router in the router accommodation range DB 220, determines, from the position information received from the communication terminal 10, which router contains the mobile communication terminal corresponding to the received position information in its accommodation range, and specifies the IP address of the accommodating router.

In the present embodiment, a method of computing the accommodating router by determining the accommodation range in which the mobile communication terminal is contained from accommodation range information is utilized, but any method that is able to specify the accommodating router from position information may be utilized. For example, a method using the distance from the mobile communication terminal shown by position information to the router may be utilized.

The position information reception/router IP reply unit 230 receives position information from the communication terminal 10, and replies to the communication terminal 10 with the IP address of the accommodating router.

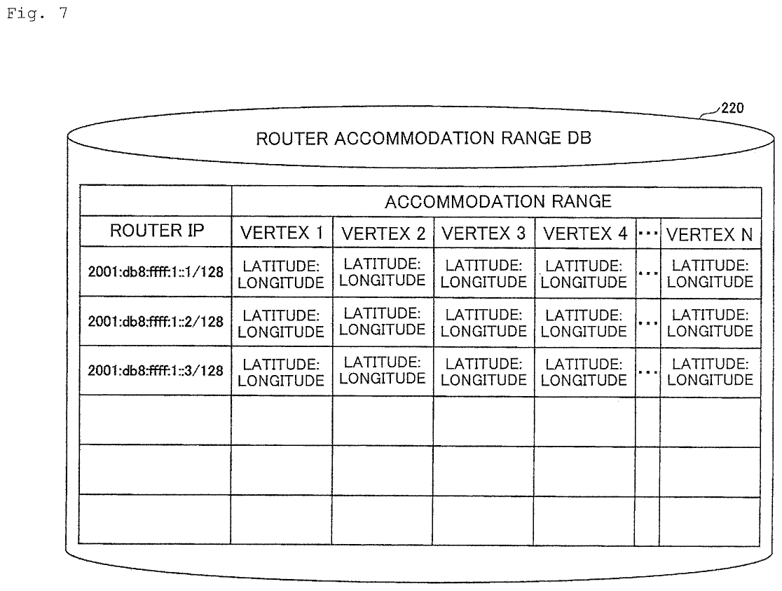

FIG. 7 shows an example of the structure of a table stored in the router accommodation range DB 220. As shown in FIG. 7, the router accommodation range DB 220 stores, for every IP address (router IP) of a router, the latitudes and longitudes of vertices that indicate the range of positions at which a mobile communication terminal accommodated by that router can be present.

<Example of Communication Operations>

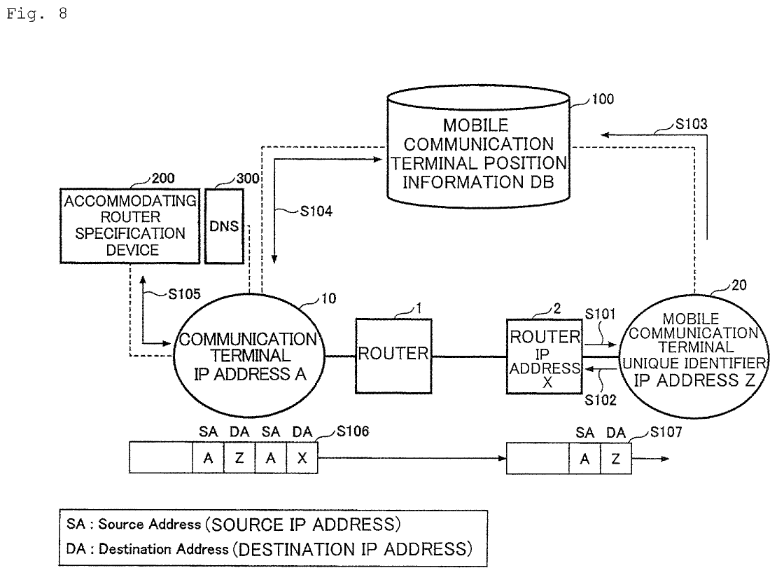

Next, an example of operations in the case of transmitting an IP packet from the communication terminal 10 to the mobile communication terminal 20 will be described; with reference to FIG. 8. A DNS 300 is shown in FIG. 8. This DNS 300 is a general DNS.

When the mobile communication terminal 20 is accommodated (connected) under the router 2, in S101, an IP address Z is assigned to the mobile communication terminal 20 by the network of the router 2.

In S102, the address notification unit 24 of the mobile communication terminal 20 advertises the IP address Z which is the unique identifier held by the mobile communication terminal 20 to the router 2. The router 2 registers the information of the received IP address Z in the routing table. The router 2 does not, however, readvertise the information of the IP address Z to the router 1.

In S103, the registration unit 23 of the mobile communication terminal 20 registers the IP address Z which is the unique identifier held by the mobile communication terminal 20 and the position information (latitude and longitude, etc.) of the mobile communication terminal 20 acquired by the position information acquisition unit 22 (GPS, etc.) in the mobile communication terminal position information DB 100.

In S104, when the communication terminal 10 having an IP address A communicates with the mobile communication terminal 20, the acquisition unit 12 of the communication terminal 10 acquires the position information of the mobile communication terminal 20 from the mobile communication terminal position information DB 100 with the IP address Z acquired from the DNS 300 as a key.

In S105, the acquisition unit 12 of the communication terminal 10 acquires the IP address X of the router 2 under which the mobile communication terminal 20 is accommodated, by making an inquiry to the accommodating router specification device 200 with the position information acquired in S104 as a key.

In S106, the communication unit 11 of the communication terminal 10, at the time of generating an IP packet addressed to the mobile communication terminal 20, creates an IP header in which the destination address is set to Z and the source address is set to A, further creates an IP header in which the destination IP address is set to X and the source IP address is set to A utilizing a technology such as IP in IP, creates an IP packet to which these IP headers are attached, and transmits the IP packet.

The IP packet transmitted from the communication terminal 10 arrives at the router 2, and, in S107, the router 2 removes the outer IP header of the received IP packet, and transmits the IP packet to Z which is the destination of the inner IP header.

### Second Embodiment

Next, a second embodiment will be described. The second embodiment is based on the first embodiment. Hereinafter, the differences from the first embodiment will be described.

In the second embodiment, specification of the IP address of the router 2 to which the mobile communication terminal 20 serving as the communication destination of the communication terminal 10 is connected and encapsulation of IP packets is performed by the router 1. It is thereby unnecessary for the communication terminal 10 to be provided with the acquisition unit 12. Also, it is unnecessary for the communication unit 11 to be provided with the encapsulation function.

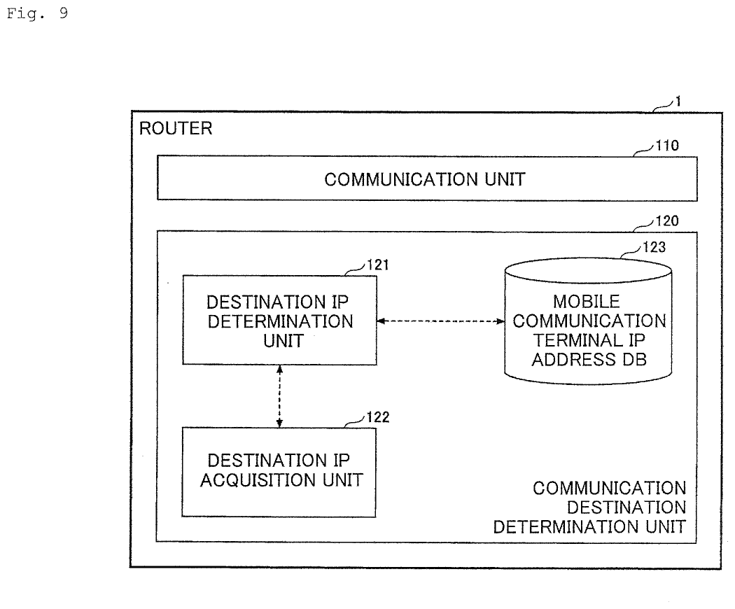

FIG. 9 is a configuration diagram of the router 1 in the second embodiment. As shown in FIG. 9, the router 1 has a communication unit 110 and a communication destination determination unit 120. The communication destination determination unit 120 has a destination IP determination unit 121, a destination IP acquisition unit 122, and a mobile communication terminal IP address DB 123. Note that, in the example in FIG. 9, the communication destination determination unit 120 is provided inside the router 1, but may be provided outside the router 1. Also, the functions of the accommodating router specification device 200 may be provided in the router 1. The communication destination determination unit 120 may also be referred to as an “acquisition unit”.

The communication unit 110 transmits and receives IP packets. An IP address for every mobile communication terminal is stored in the mobile communication terminal IP address DB 123 of the communication destination determination unit 120. The destination IP determination unit 121 receives, from the communication unit 110, the destination IP address of an IP packet received from a communication terminal by the communication unit 110, and searches the mobile communication terminal IP address DB 123 with the destination IP address as a key. The destination IP determination unit 121 determines that the communication destination of the IP packet transmitted from the communication terminal is a mobile communication terminal, if the IP address exists in the mobile communication terminal IP address DB 123 as the IP address of a mobile communication terminal.

If the communication destination of the IP packet transmitted from the communication terminal is determined to be a mobile communication terminal, the destination IP acquisition unit 122 acquires position information from the mobile communication terminal position information DB 100 with the destination IP address as a key, and acquires the IP address of the router under which the mobile communication terminal is accommodated from the accommodating router specification device 200 with the acquired position information as a key.

The communication unit 110 performs IP address encapsulation with a header having the IP address of the router under which the mobile communication terminal is accommodated.

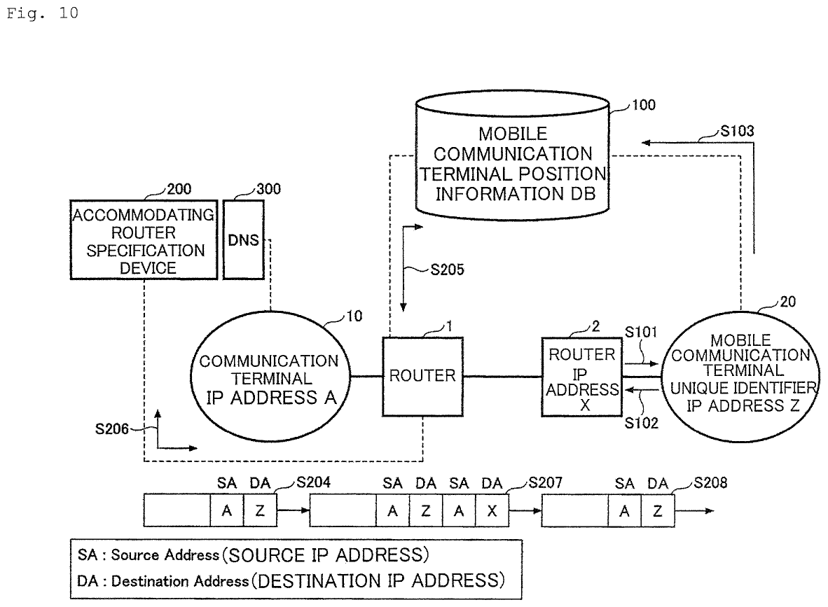

An example of operations in the second embodiment will be described, with reference to FIG. 10. The description will focus on the differences from the first embodiment (FIG. 8).

In S204, the communication terminal 10 transmits an IP packet having an IP header in which the destination address is set to Z and the source address is set to A. The communication unit 110 of the router 1 receives this IP packet.

The destination IP determination unit 121 receives, from the communication unit 110, the destination IP address Z of the IP packet received from the communication terminal 10 by the communication unit 110, and searches the mobile communication terminal IP address DB 123 with the destination IP address Z as a key. Here, the destination IP determination unit 121 determines that the communication destination of the IP packet transmitted from the communication terminal 10 is a mobile communication terminal.

In S205, the destination IP acquisition unit 122 of the router 1 acquires position information corresponding to the destination IP address Z from the mobile communication terminal position information DB 100, by making an inquiry to the mobile communication terminal position information DB 100 with the destination IP address Z as a key.

In S206, the destination IP acquisition unit 122 of the router 1 acquires the IP address X of the router 2 under which the mobile communication terminal 20 is accommodated from the accommodating router specification device 200, by making an inquiry to the accommodating router specification device 200 with the acquired position information as a key.

In S207, the communication unit 110 creates an IP header in which the destination IP address is set to X and the source IP address is set to A utilizing technology such as IP in IP, creates an IP packet to which the IP header is attached, and transmits the IP packet. S208 is the same as S107 of the first embodiment.

### Third Embodiment

Next, a third embodiment will be described. The third embodiment is also based on the first embodiment. Hereinafter, differences from the first embodiment will be described.

In the third embodiment, each communication terminal and router supports IPv6 Segment Routing (SRv6). Segment Routing is a technology that is able to perform communication path designation and the like, based on information added to the packet header at the entrance to a network or to like.

In the third embodiment, by utilizing a SID list in an SR header of IPv6 Segment Routing (SRv6) when a communication terminal transmits a packet to a mobile communication terminal, packets can be forwarded without decapsulation processing (removal of outer IP header) in the accommodating router of the mobile communication terminal.

In the third embodiment, an SRv6 function is added to the routers of the first embodiment, and the SRv6 function operates. In an IP network in which the SRv6 function operates, forwarding of packets is possible with IPv6 address information in the SID list. The communication terminal 10 and the mobile communication terminal 20 also have the SRv6 function. Path control is also realized by designating routers on the communication path in the SID list of the SR header.

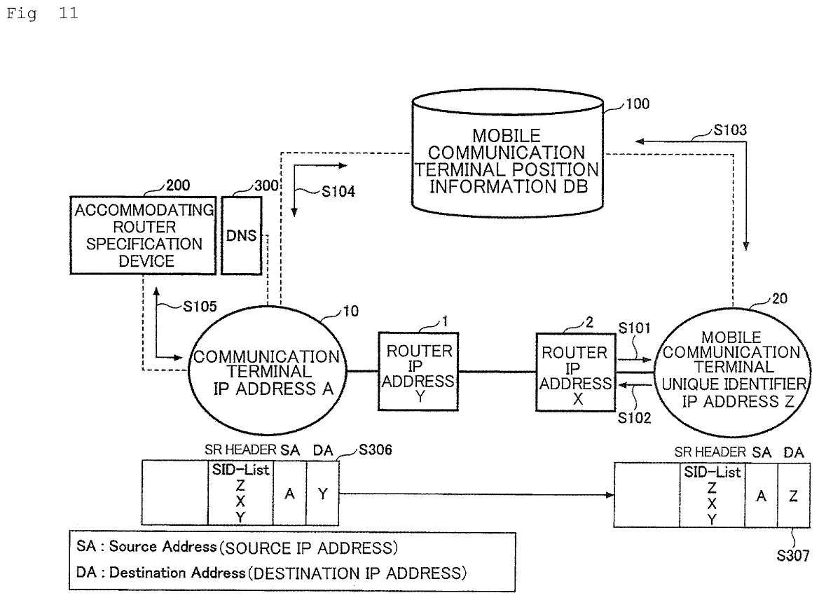

An example of operations in the third embodiment will be described, with reference to FIG. 11. The description will focus on the differences from the first embodiment (FIG. 8). The IP address of the router 1 is Y. The communication terminal 10 knows that the IP address of the router 1 is Y.

In S306, after S101 to S105, the communication unit 11 of the communication terminal 10, at the time of generating an IP packet addressed to the mobile communication terminal 20, creates an SR header having a SID list consisting of Z, X and Y, further creates an IP header in which the destination IP address is set to Y and the source IP address is set to A, creates an IP packet to which the SR header and IP header are attached, and transmits the IP packet.

The IP packet transmitted from the communication terminal 10 arrives at the router 2. In S307, the router 2 forwards the IP packet with the IP address Z as the destination.

Note that the SRv6 header insertion mode described in the third embodiment is an example. Any header attachment method that is defined by SRv6 may be used.

### Fourth Embodiment

Next, a fourth embodiment will be described. The fourth embodiment is based on the third embodiment, and corresponds to a combination of the second and third embodiments. The following description will focus on the differences from the third embodiment.

In the fourth embodiment, specification of the IP address of the router 2 to which the mobile communication terminal 20 serving as the communication destination of the communication terminal 10 is connected and insertion of an SR header to IP packets is performed by the router 1. The configuration of the router 1 in the fourth embodiment is as shown in FIG. 9.

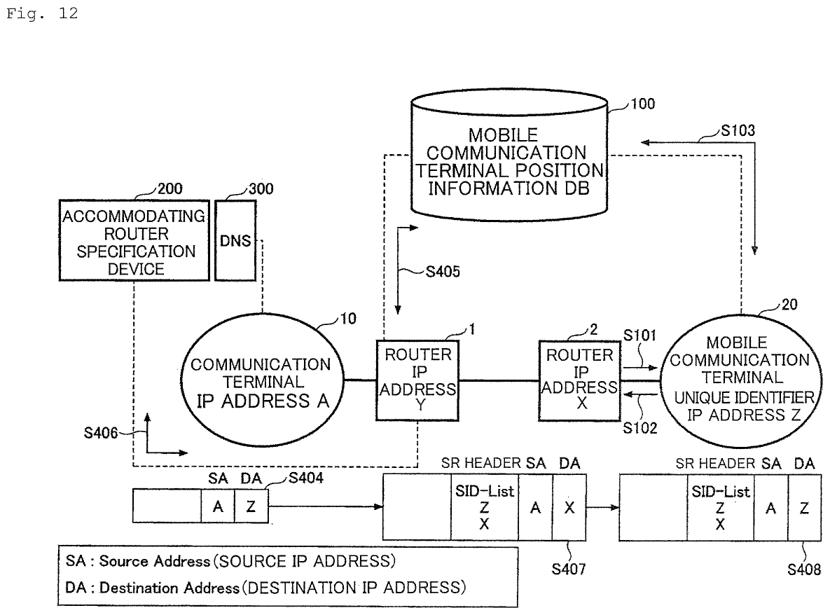

An example of operations in the fourth embodiment will be described, with reference to FIG. 12. The following description will focus on the differences from the third embodiment (FIG. 11).

In S404, after S101 to S103, the communication terminal 10 transmits an IP packet having an IP header in which the destination address is set to Z and the source address is set to A. The communication unit 110 of the router 1 receives this IP packet.

The destination IP determination unit 121 receives, from the communication unit 110, the destination IP address Z of the IP packet received from the communication terminal 10 by the communication unit 110, and searches the mobile communication terminal IP address DB 123 with the destination IP address Z as a key. Here, the destination IP determination unit 121 determines that the communication destination of the IP packet transmitted from the communication terminal 10 is a mobile communication terminal.

In S405, the destination IP acquisition unit 122 of the router 1 acquires position information corresponding to the destination IP address Z from the mobile communication terminal position information DB 100, by making an inquiry to the mobile communication terminal position information DB 100 with the destination IP address Z as a key.

In S406, the destination IP acquisition unit 122 of the router 1 acquires the IP address X of the router 2 under which the mobile communication terminal 20 is accommodated from the accommodating router specification device 200, by making an inquiry to the accommodating router specification device 200 with the acquired position information as a key.

In S407, the communication unit 110 creates an SR header having a SID list consisting of Z and X, further creates an IP header in which the destination IP address is set to X and the source IP address is set to A, creates an IP packet to which the SR header and IP header are attached, and transmits the IP packet.

The IP packet forwarded from the router 1 arrives at the router 2. In S408, the router 2 forwards the IP packet with the IP address Z as the destination.

(Example Hardware Configuration)

The devices (communication terminals, mobile communication terminals, routers, mobile communication terminal position information DB, accommodating router specification device) described in the embodiments can all be realized by executing a computer program that describes the processing contents illustrated in the embodiments.

The devices can be realized by executing a program corresponding to the processing that is implemented by the devices, using hardware resources such as a CPU and a memory embedded in a computer. The program can be saved, distributed and the like by being recorded on a computer-readable recording medium (portable memory, etc.). The program can also be provided through a network such as the internet or email.

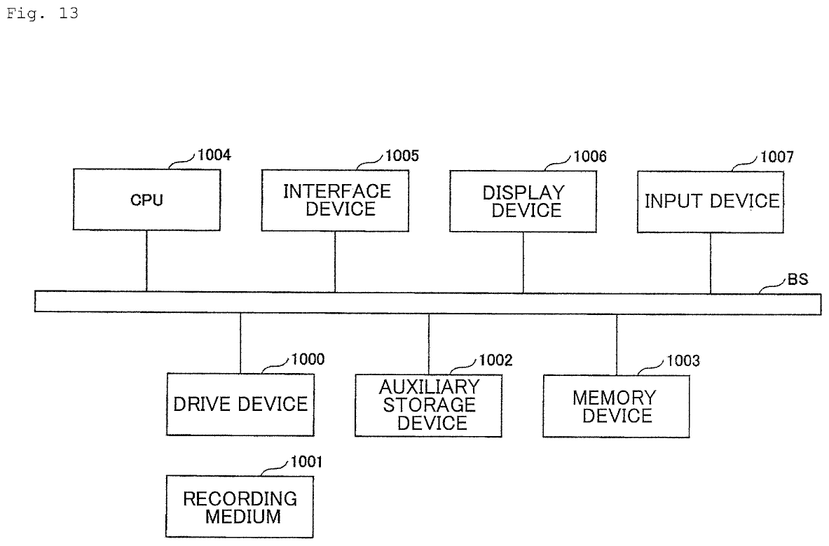

FIG. 13 is a diagram showing an example hardware configuration of the computer. The computer in FIG. 13 has a drive device 1000, an auxiliary storage device 1002, a memory device 1003, a CPU 1004, an interface device 1005, a display device 1006, an input device 1007 and the like that are connected to each other by a bus B.

A program for realizing the processing of the computer is provided by a recording medium 1001 such as a CD-ROM or a memory card, for example. When the recording medium 1001 storing the program is set in the drive device 1000, the program is installed onto the auxiliary storage device 1002 from the recording medium 1001 via the drive device 1000. The program does not, however, necessarily need to be installed from the recording medium 1001, and may be downloaded from another computer via a network. The auxiliary storage device 1002 stores necessary files, data and the like, together with storing the installed program.

The memory device 1003 reads out and stores the program from the auxiliary storage device 1002, if there is a program activation instruction. The CPU 1004 realizes the functions related to the devices, in accordance with the program stored in the memory device 1003. The interface device 1005 is used as an interface for connecting to a network. The display device 1006 displays a GUI (Graphical User Interface) of the program, and the like. The input device 1007 is constituted by a keyboard and a mouse, buttons or a touch panel, and is used in order to allow input of various operating instructions.

### SUMMARY OF EMBODIMENTS

As described above, in the system according to the embodiments of the present invention, when a communication terminal communicates to a mobile communication terminal in an IP network constituted by a plurality of routers, the router under which the mobile communication terminal is accommodated is dynamically computed from the position information of the mobile communication terminal. The communication terminal performs encapsulation by further attaching an IP header whose destination is the IP address of the accommodating router to the original IP packet, and transmits the IP packet to which IP header is attached. The accommodating router removes the attached IP header and forwards the packet addressed to the destination IP address of the original IP packet.

The processing for encapsulating IP packets may be performed by the router. IP packet encapsulation by the communication terminal is thereby unnecessary. IPv6 Segment Routing (SRv6) may be used as the means of forwarding IP packets. The processing for removing the attached IP header in the accommodating router is thereby unnecessary.

Also, the processing for attaching an SR header to IP packets may be performed by the router. The SRv6 function is thereby unnecessary in the communication terminal and mobile communication terminal.

### Effects of Embodiments

According to the present embodiment, the transmission destination of packets is specified utilizing the position information of mobile communication terminals, and thus each router no longer needs to hold a huge routing table. That is, it becomes possible to perform IP communication from a communication terminal to any mobile communication terminal, without holding a huge amount of data in each router on the network.

(Supplementary Notes)

This specification describes at least the communication device, mobile communication terminal, communication method and computer programs that are described in the following notes.

(First Note)

A communication device for use in a system including a database storing a unique identifier and position information for every mobile communication terminal, the communication device including:

an acquisition unit configured to acquire, based on a unique identifier of a mobile communication terminal serving as a communication destination, position information of the mobile communication terminal serving as the communication destination from the database, and to acquire an IP address of a router accommodating the mobile communication terminal serving as the communication destination, based on the acquired position information; and

a communication unit configured to transmit a packet having the IP address in a header.

(Second Note)

The communication device according to the first note,

the acquisition unit acquiring, from a database storing, for every router, an IP address of the router and an accommodation range of the router, an IP address of the router accommodating the mobile communication terminal serving as the communication destination.

(Third Note)

The communication device according to the first or second note,

the communication device being a router accommodating a communication terminal, and

the acquisition unit, in a case where the communication destination of a packet received from the communication terminal is determined to be a mobile communication terminal, acquiring the IP address of the router accommodating the mobile communication terminal serving as the communication destination.

(Fourth Note)

A mobile communication terminal for use in a system including a database storing a unique identifier and position information for every mobile communication terminal, the mobile communication terminal including:

an address notification unit configured to advertise a unique identifier of the mobile communication terminal to a router accommodating the mobile communication terminal; and

a registration unit configured to register the unique identifier and position information of the mobile communication terminal in the database.

(Fifth Note)

A communication method to be executed by a communication device for use in a system including a database storing a unique identifier and position information for every mobile communication terminal, the communication method including:

an acquisition step of acquiring, based on a unique identifier of a mobile communication terminal serving as a communication destination, position information of the mobile communication terminal serving as the communication destination from the database, and acquiring an IP address of a router accommodating the mobile communication terminal serving as the communication destination, based on the acquired position information; and a communication step of transmitting a packet having the IP address in a header.

(Sixth Note)

A computer program for causing a computer to function as each unit of the communication device according to any one of the first to third notes.

(Seventh Note)

A computer program for causing a computer to function as each unit of the mobile communication terminal according to the fourth note;

Although embodiments have been described above, the present invention is not limited to these specific embodiments, and various modifications and changes can be made within the scope of the gist of the invention as described in the claims.

### REFERENCE SIGNS LIST

1-4 Router
10 Communication terminal
11 Communication unit
12 Acquisition unit
13 Accommodating router specification unit
20 Mobile communication terminal
21 Communication unit
22 Position information acquisition unit
23 Registration unit
24 Address notification unit
100 Mobile communication terminal position information DB
110 Communication unit
120 Communication destination determination unit
121 Destination IP determination unit
122 Destination IP acquisition unit
123 Mobile communication terminal IP address DB
200 Accommodating router specification device
210 Accommodating router computation unit
220 Router accommodation range DB
230 Position information reception/router IP reply unit
300 DNS
1000 Drive device
1001 Recording medium.
1002 Auxiliary storage device
1003 Memory device
1004 CPU
1005 Interface device
1006 Display device
1007 Input device

1. A communication device for use in a system including a database storing a unique identifier and position information for every mobile communication terminal, the communication device comprising:
a processor; and
a memory storing program instructions that cause the processor to:
acquire, based on a unique identifier of a mobile communication terminal serving as a communication destination, position information of the mobile communication terminal serving as the communication destination from the database, and to acquire an IP address of a router accommodating the mobile communication terminal serving as the communication destination, based on the acquired position information; and
transmit a packet having the IP address in a header.

2. The communication device according to claim 1,
wherein the program instructions further cause the processor to acquire, from a database storing, for every router, an IP address of the router and an accommodation range of the router, an IP address of the router accommodating the mobile communication terminal serving as the communication destination.

3. The communication device according to claim 1,
wherein the communication device is a router accommodating a communication terminal, and
the program instructions further cause the processor to, in a case where the communication destination of a packet received from the communication terminal is determined to be a mobile communication terminal, acquire the IP address of the router accommodating the mobile communication terminal serving as the communication destination.

4. A mobile communication terminal for use in a system including a database storing a unique identifier and position information for every mobile communication terminal, the mobile communication terminal comprising:
a processor; and
a memory storing program instructions that cause the processor to:
advertise a unique identifier of the mobile communication terminal to a router accommodating the mobile communication terminal; and
register the unique identifier and position information of the mobile communication terminal in the database.

5. A communication method to be executed by a communication device for use in a system including a database storing a unique identifier and position information for every mobile communication terminal, the communication method comprising:
acquiring, based on a unique identifier of a mobile communication terminal serving as a communication destination, position information of the mobile communication terminal serving as the communication destination from the database, and acquiring an IP address of a router accommodating the mobile communication terminal serving as the communication destination, based on the acquired position information; and
transmitting a packet having the IP address in a header.

6. A non-transitory computer-readable storage medium that stores therein a computer program for causing a computer to function as the communication device according to claim 1.

7. A non-transitory computer-readable storage medium that stores therein a computer program for causing a computer to function as the mobile communication terminal according to claim 4.
